(19) United States
(12) Patent Application Publication
(10) Pub. No.: US 2018/0073662 A1
(43) Pub. Date: Mar. 15, 2018

(54) GAS REGULATOR ASSEMBLY

(71) Applicant: YUNG SHEN GAS APPLIANCE CO., LTD., CHIA-YI CITY (TW)

(72) Inventor: CHENG-SHENG HSIAO, CHIA-YI CITY (TW)

(21) Appl. No.: 15/262,316

(22) Filed: Sep. 12, 2016

(51) Int. Cl. F16K 37/00

(52) U.S. Cl. CPC F16K 37/0008; F16K 37/0058

(57) ABSTRACT

A gas regulator assembly is revealed. A display device is mounted in a chamber of a gas regulator. A piston base of the display device is stopped in a vent hole of the gas regulator by a stopper. An elastic part arranged between a push base of a push part of the piston base and a circular flange around the push base is against a support seat. An extension part is extended from the support seat and covered by the circular flange when the push base and the support seat are leaning against each other. A display film with grooves is set on the support seat. An outer cap is covered on the chamber and having a transparent circular window on one end and a transparent outer window on the other end. Thereby the risk of gas leakage is minimized and the safety in use is improved.

### BACKGROUND OF THE INVENTION

### Field of the invention

The present invention relates to a gas regulator assembly, especially to a gas regulator assembly that not only prevents cracks or damages of a display device during use but also minimized the risk of gas leakage so as to ensure a greater safety of the gas regulator assembly in use.

### Descriptions of Related Art

Refer to Chinese Pat. No. CN 204664522 U, a common gas regulator structure is revealed. The gas regulator includes a first segment and a second segment connected to each other. A chamber is formed concavely on an outer side of the first segment and communicating with inner space thereof. An intake valve is arranged in the chamber and a film is disposed on the intake valve. A push seat is set on an outer end of the film while a projecting ring is formed on an outer edge of an inner end of the push seat. An elastic member is arranged between the push seat and the projecting ring while a support seat is disposed on an outer end of the push seat and the support seat is against an outer end of the elastic member. An extension segment is extended from an inner end of the support seat and is corresponding to an outer edge of the elastic member. An insertion hole is disposed on the support seat and is corresponding to the push seat. A display with slots is set on an outer end of the support seat. An outer cover is set over an outer shield of the chamber of the first segment. The outer cover includes a transparent side window disposed around one end thereof and a transparent display window set on an outer end thereof.

Although the above gas regulator allows users to learn the current condition of the gas supply, it has certain problems while in use. The film is always pushed by the push seat being moved by gas input. Thus the film may be cracked, damaged or fallen off after long term use or when the pressure of the gas input is too high. This leads to gas leakage and the safety in use of the gas regulator assembly is affected. There is room for improvement and a need to provide a novel structure of the gas regulator.

### SUMMARY OF THE INVENTION

Therefore it is a primary object of the present invention to provide a gas regulator assembly that not only prevents cracks or damages of a display device during use but also minimizes the risk of gas leakage. Thus a greater safety of the gas regulator assembly in use is ensured.

In order to achieve the above object, a gas regulator assembly of the present invention mainly includes a gas regulator and a display device. The gas regulator is composed of a vent hole communicating with outside and a chamber disposed on an outer side of the vent hole. The display device is mounted in the chamber of the gas regulator. The display consists of a piston base mounted in the vent hole of the gas regulator and a stopper disposed on an outer edge of the vent hole for stopping the piston base inside the vent hole. A push part is projecting from the piston base and is out of the vent hole. A push base corresponding to the push part is mounted in the chamber and a circular flange is formed around the push base. An elastic part is arranged between the push base and the circular flange. A support seat is disposed on an outer end of the push base and is against an outer end of the elastic part. An extension part is arranged at one side of the support seat facing the elastic part. The circular flange just covers the extension part when the push base and the support seat are leaning against each other. An insertion hole is mounted on the support seat, allowing the push base to pass through. A display film is set on an outer end of the support seat. A plurality of grooves is extended radially from a center of the display film so that the push base can be passed through the display film. An outer cap is covered on the chamber and having a transparent circular window disposed on one end thereof and a transparent outer window on the other end thereof.

A gasket is arranged between the push base and the chamber.

A protective cap is located outside the outer cap and having a through hole corresponding to the outer window of the outer cap.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a perspective view of an embodiment according to the present invention;

FIG. 3 is a longitudinal sectional view of an embodiment according to the present invention;

FIG. 4 is a longitudinal sectional view of an embodiment in use according to the present invention.

### DETAILED DESCRIPTION OF THE PREFERRED EMBODIMENT

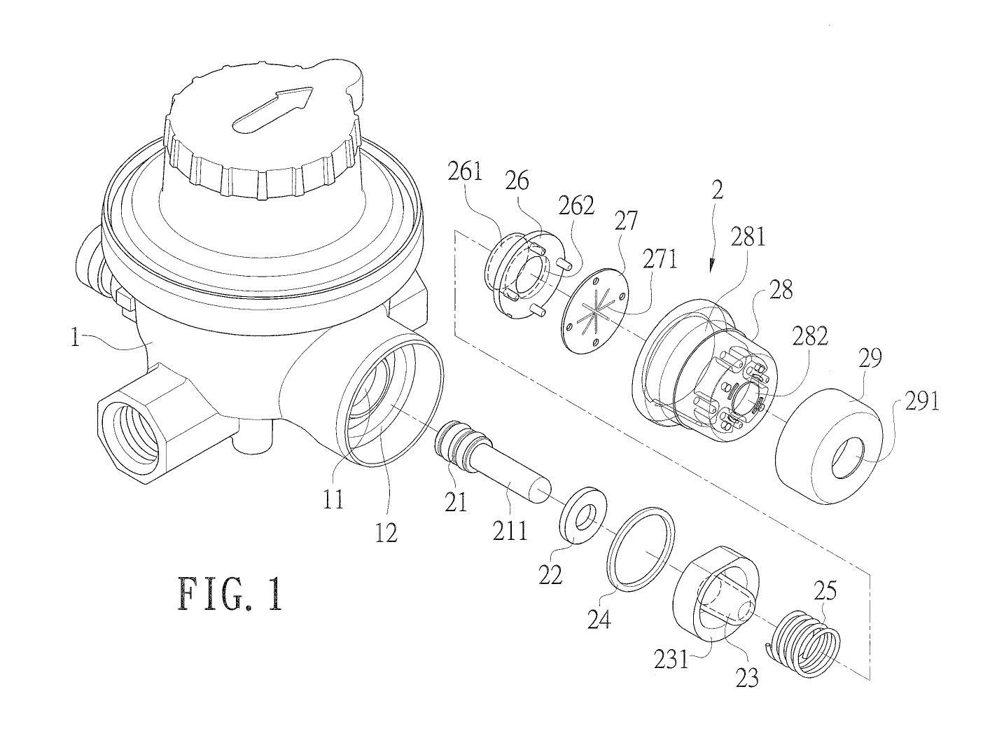

Refer to FIG. 1, a gas regulator assembly of the present invention mainly includes a gas regulator 1 and a display device 2.

The gas regulator 1 consists of a vent hole 11 communicating with outside and a chamber 12 disposed on the outer side of the vent hole 11.

The display device 2 is mounted in the chamber 12 of the gas regulator 1 and is composed of a piston base 21, a stopper 22, a push base 23, a gasket 24, an elastic part 25, a support seat 26, a display film 27, an outer cap 28, and a protective cap 29. The piston base 21 is mounted in the vent hole 11 of the gas regulator 1 while the stopper 22 is disposed an outer edge of the vent hole 11 and used for limiting the piston base 21 inside the vent hole 11. A push part 211 is projecting from the piston base 21 and is out of the vent hole 11. The push base 23 is corresponding to the push part 211 and mounted in the chamber 12 while a circular flange 231 is formed around the push base 23. The gasket 24 is arranged between the push base 23 and the chamber 12. The elastic part 25 is set between the push base 23 and the circular flange 231. The support seat 26 is disposed on an outer end of the push base 23 and is against the outer end of the elastic part 25. Thus the push base 23 and the support seat 26 are always separated from each other owing to a support force provided by the elastic part 25. An extension part 261 is arranged at one side of the support seat 26 facing the elastic part 25. When the push base 23 and the support seat 26 are leaning against each other, the circular flange 231 just covers the extension part 261. An insertion hole 262 is set on the support seat 26, allowing the push base 23 to pass through. The display film 27 is set on an outer end of the support seat 26. A plurality of grooves 271 is radially extended from a center of the display film 27 so that the push base 23 can be passed through the display film 27. The outer cap 28 is covered on the chamber 12 and having a transparent circular window 281 disposed on one end thereof and a transparent outer window 282 set on the other end thereof, opposite to the end with the circular window 281. The protective cap 29 is located outside the outer cap 28 and having a through hole 291 corresponding to the outer window 282 of the outer cap 28.

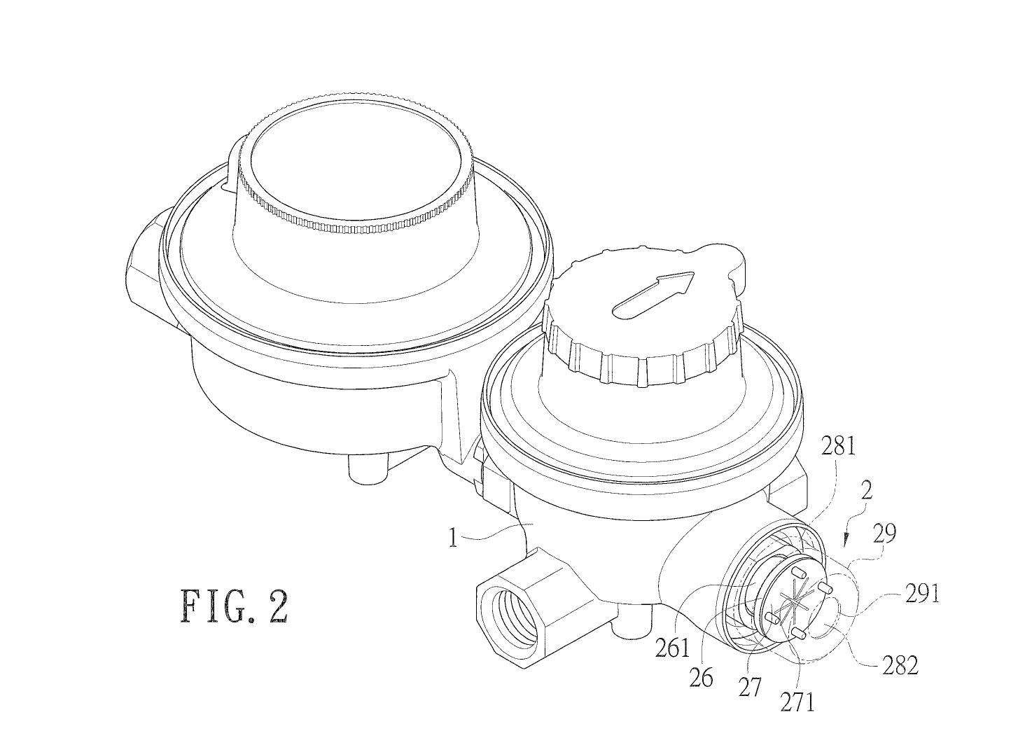

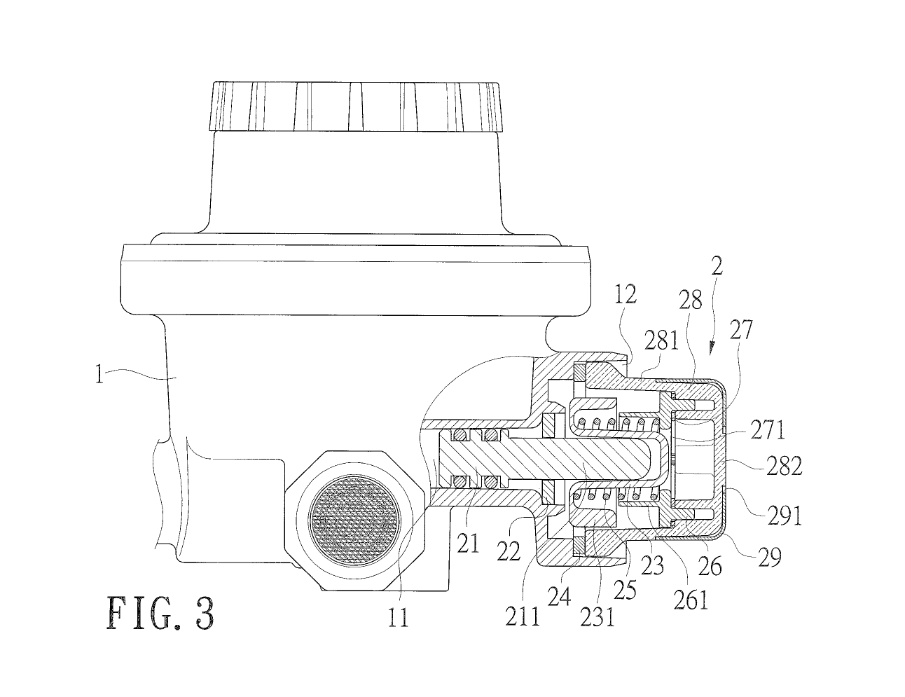

Refer to FIG. 2 and FIG. 3, the push base 23 and the support seat 26 of the display device 2 are separated from each other owing to a support force provided by the elastic part 25 when there is no gas input into the gas regulator 1. Thus users can observe the color shown on the extension part 261 of the support seat 26 through the circular window 281 on one end of the outer cap 28 and the color of the display film 27 through the outer window 282 on the other end of the outer cap 28. Thus users can learn that there is no gas introduced or the gas is run out.

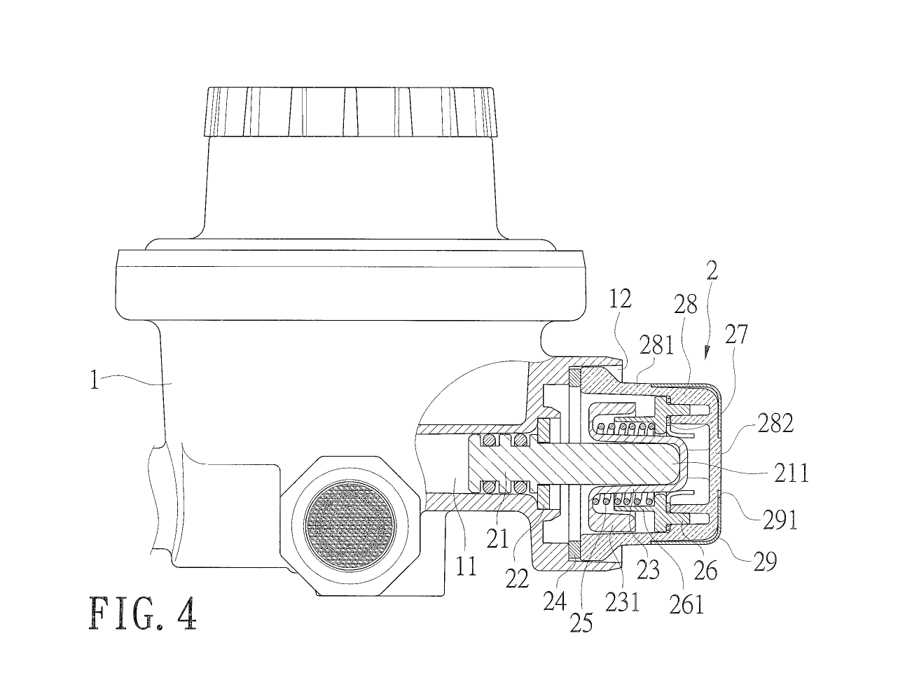

Refer to FIG. 4, gas coming from the vent hole 11 will push the piston base 21 of the display device 2 to move outward so that the push part 211 disposed on the piston base 21 is also moved outward to push the push base 23 when gas is input into the gas regulator 1. Thus the elastic part 25 is compressed by the push base 23 and the push base 23 is moved toward the support seat 26. Now the circular flange 231 of the push base 23 is moved to cover the extension part 261 of the support seat 26. Thus the color users observed through the circular window 281 on one end of the outer cap 28 is changed to the color shown on the circular flange 231. At the same time, the front end of the push base 23 is passed through the insertion hole 262 of the support seat 26 and the grooves 271 of the display film 27. Thus users can observe the color shown on the push base 23 through the outer window 282 of the outer cap 28 and the through hole 291 of the protective cap 29 so as to learn that there is sufficient gas available.

In summary, compared with the technique available now, the gas regulator assembly of the present invention not only prevents the display device from cracks or damages but also avoids gas leakage for safe use of the gas. A greater safety of the gas regulator assembly in use is ensured.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A gas regulator assembly comprising a gas regulator and a display device;
wherein the gas regulator includes a vent hole communicating with outside and a chamber disposed on an outer side of the vent hole;
wherein the display device is mounted in the chamber of the gas regulator and having a piston base, a stopper, a push base, a gasket, an elastic part, a support seat, a display film, and an outer cap; the piston base is mounted in the vent hole of the gas regulator and the stopper is disposed on an outer edge of the vent hole for stopping the piston base inside the vent hole; a push part is projecting from the piston base and is out of the vent hole; the push base corresponding to the push part is mounted in the chamber and a circular flange is formed around the push base; the elastic part is arranged between the push base and the circular flange; the support seat is disposed on an outer end of the push base and is against an outer end of the elastic part; an extension part is arranged at one side of the support seat facing the elastic part and is covered by the circular flange when the push base and the support seat are leaning against each other; an insertion hole is mounted on the support seat and used for allowing the push base to pass through; the display film is arranged at an outer end of the support seat and a plurality of grooves is radially extended from a center of the display film so that the push base can be passed through the display film; the outer cap is covered on the chamber and having a transparent circular window formed on one end thereof and a transparent outer window on the other end thereof.

2. The device as claimed in claim 1, wherein the gasket is arranged between the push base and the chamber.

3. The device as claimed in claim 1, wherein a protective cap is located outside the outer cap and having a through hole corresponding to the outer window of the outer cap.
